(19) United States
(12) Patent Application Publication
(10) Pub. No.: US 2014/0329125 A1
(43) Pub. Date: Nov. 6, 2014

(54) UNDERCOVER

(71) Applicant: MITSUBISHI JIDOSHA KOGYO KABUSHIKI KAISHA, Tokyo (JP)

(72) Inventors: Satoshi MIYANAGA, Tokyo (JP); Makoto TAKEHARA, Tokyo (JP); Masaki OCHI, Tokyo (JP); Ko ASAI, Okazaki-shi (JP); Takanori YAMAMOTO, Okazaki-shi (JP)

(21) Appl. No.: 14/332,822

(22) Filed: Jul. 16, 2014

Related U.S. Application Data
(63) Continuation of application No. PCT/JP2013/050561, filed on Jan. 15, 2013.

(30) Foreign Application Priority Data
Jan. 17, 2012 (JP) 2012-007256

(51) Int. Cl. H01M 2/10

(52) U.S. Cl. CPC H01M 2/1094
USPC 429/100

(57) ABSTRACT

An undercover is provided which can have an electromagnetic shield effect in a vehicle. A battery unit is provided at a lower portion of a car body. The undercover is provided under the battery unit. The undercover functions to prevent an obstruction or a stone leaping during driving from directly hitting on a battery case. The undercover includes an undercover body and a cloth electromagnetic shield member formed of a conductive fabric. The conductive fabric is soft and flexible, and is molded along with the undercover body, with resin of the undercover body heated, so that they unite with each other. The resin is melted and stuck to the conductive fabric to obtain an anchor effect, as a result of which the conductive fabric is fixed to the resin of the undercover body.

### CROSS REFERENCE TO RELATED APPLICATIONS

This application is a Continuation Application of PCT Application No. PCT/JP2013/050561, filed Jan. 15, 2013 and based upon and claiming the benefit of priority from prior Japanese Patent Application No. 2012-007256, filed Jan. 17, 2012, the entire contents of all of which are incorporated herein by reference.

### BACKGROUND OF THE INVENTION

1. Field of the Invention

The present invention relates to an undercover for a vehicle, which is provided at a vehicle comprising a battery unit and an electric motor for driving.

2. Description of the Related Art

It is known that in a vehicle provided with an electric motor employing a battery as its power supply, an electromagnetic wave is generated from, e.g., the electric motor, the battery or a current control circuit. There is apprehension that an electromagnetic wave generated at a vehicle affects various kinds of electric components. Thus, it is hoped that an electromagnetic shield measure is taken for electric components which may be affected by an electromagnetic wave or electric components which generate an electromagnetic wave.

For example, as an electromagnetic shield measure for a battery case, it is proposed that a surface of the battery case is coated with an electromagnetic shield paint which functions to reflect an electromagnetic wave, as described in Jpn. Pat. Appln. KOKAI Publication No. 8-186390 (Patent Literature 1). Also, as another electromagnetic shield measure for a battery case, it is proposed that a wire net is embedded in a resin layer, as described in Jpn. Pat. Appln. KOKAI Publication No. 2001-294048 (Patent Literature 2).

In the case where an electromagnetic shield paint is applied onto a surface, etc. of a battery case as in Patent Literature 1, it is expensive and thus disadvantageous. In addition, it is also necessary to carry out steps of applying the paint and of drying the paint. Therefore, it takes long time to take an electromagnetic shield measure, and in addition it is very expensive.

In the case where a wire net is embedded in a battery case as in Patent Literature 2, an electronic component provided outside the battery case cannot be shielded against an electromagnetic wave applied from an area located outside the battery case. Furthermore, there is a case where the shape of the battery case varies in accordance with specifications of a battery module provided in the battery case. Therefore, the electromagnetic shield measure to be taken varies from one kind of battery case to another, and thus lacks versatility. In addition, in the case where the wire net is provided in the battery case, it causes electrical shortings in a narrow space of the inside of the battery case.

### BRIEF SUMMARY OF THE INVENTION

Therefore, the object of the present invention is to provide an undercover which can effectively function as electromagnetic shield means also.

The present invention relates to an undercover provided under a battery unit attached to a lower portion of a vehicle, comprising an undercover body formed of resin and located opposite to a bottom surface of the battery unit; and a conductive fabric stacked on the undercover body, the conductive fabric comprising conductive fibers woven thereinto; wherein the undercover body is melted and stuck to the conductive fabric.

In an embodiment of the present invention, the undercover body includes a convex edge located at its peripheral edge to project upwards, and the conductive fabric is provided over an area surrounded by the convex edge. In the embodiment, the convex edge includes: a front edge portion located closer to a front side of the vehicle than a front surface of the battery unit; a rear edge portion located closer to a rear side of the vehicle than a rear surface of the battery unit; and both side edge portions located closer to outer peripheral sides of the vehicle than both side surfaces of the battery unit, and an edge portion of the conductive fabric may be provided over the front edge portion, the rear edge portion and the both side edge portions.

In another embodiment of the present invention, metallic bolts are provided to penetrate the undercover and the conductive fabric in a thickness direction, and are also fixed to metallic frame members of the vehicle. In this structure, the conductive fabric is grounded by the bolts on a vehicle side.

Furthermore, on an upper surface of the conductive fabric, a laminate resin layer may be stacked. In this embodiment, the laminate resin layer and the undercover body may be formed of resin (e.g., polypropylene) having compatibility with each other, and be fused together, with the conductive fabric interposed between the resin of the laminate resin layer and that of the undercover body.

According to the present invention, it is possible to take an electromagnetic shield measure for the battery unit, etc., using the undercover, which is provided on a lower portion of the vehicle. Also, with the undercover, it is possible prevent an electromagnetic wave generated from the battery unit from affecting peripheral components such as an electronic component.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a vehicle provided with an undercover according to a first embodiment of the present invention;

FIG. 2 is a perspective view of the undercover and a frame body of the vehicle as shown in FIG. 1, as viewed from below;

FIG. 3 is a cross-sectional view of part of the vehicle as shown in FIG. 1, which is taken along a longitudinal direction of a car body of the vehicle;

FIG. 4 is a perspective view of an anterior half of the undercover;

FIG. 5 is a cross-sectional view schematically showing part of the undercover as shown in FIG. 4;

FIG. 6 is a perspective view enlargedly showing part of a conductive thread;

FIG. 7 is a perspective view enlargedly showing a conductive thread applied to an undercover according to a second embodiment of the present invention; and

FIG. 8 is a cross-sectional view of part of an undercover according to a third embodiment of the present invention.

### DETAILED DESCRIPTION OF THE INVENTION

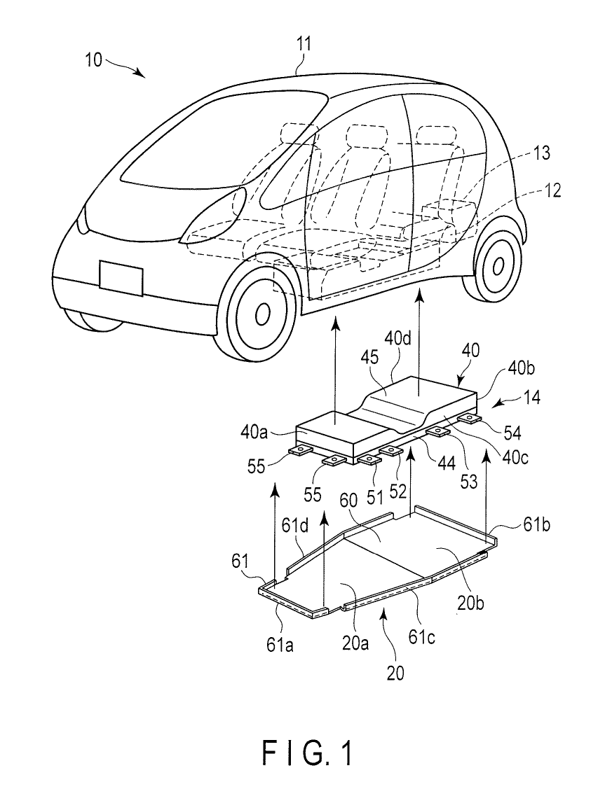

A first embodiment of the present invention will be hereinafter described with reference to FIGS. 1-6.

FIG. 1 shows a vehicle 10 comprising an electric motor for driving. The vehicle 10 comprises an electric motor 12 for driving, a charging device 13, a battery unit 14 and an undercover 20 which will be described later, the electric motor 12 and the charging device 13 being provided at a rear portion of a car body 11, the battery unit 14 being provided at a lower portion of the vehicle 10. Although an electric car is applied as an example of the vehicle 10, a hybrid car comprising an electric motor and an internal combustion engine may be applied as the vehicle 10. The battery unit 14 is provided under a floor of the car body 11.

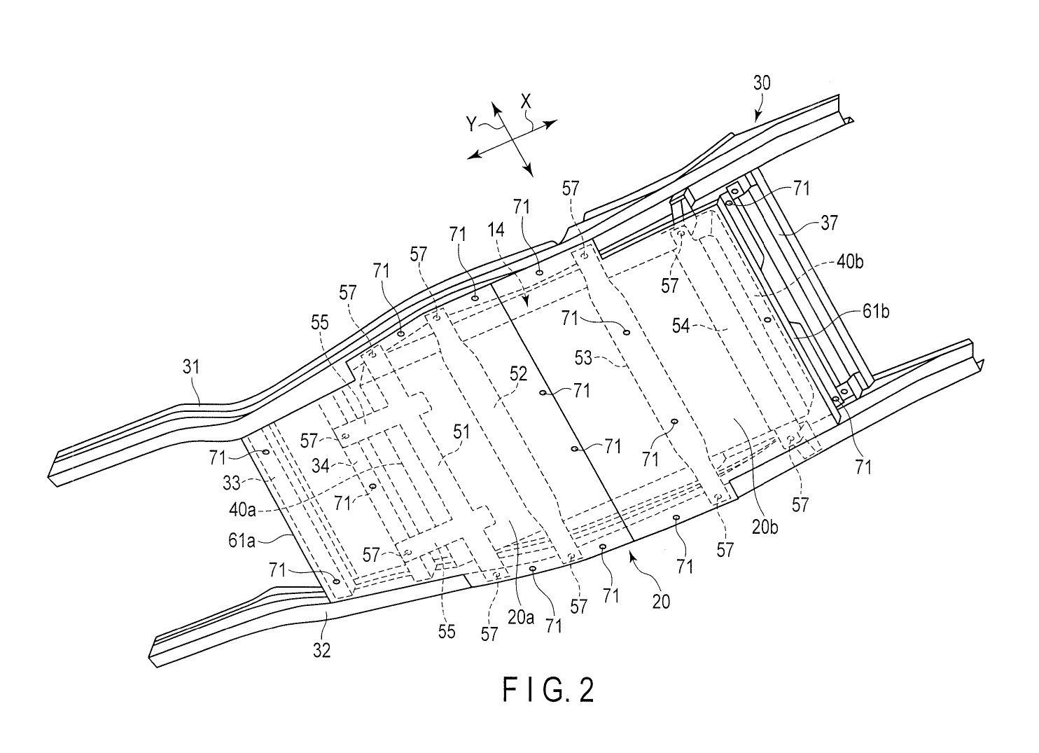

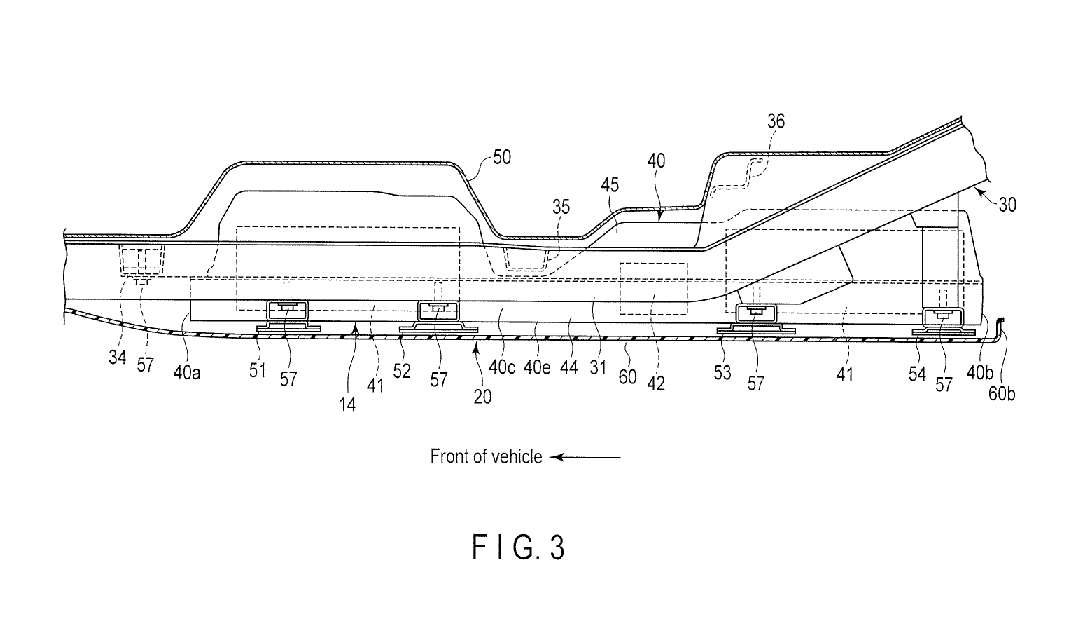

FIG. 2 shows a frame body 30 forming a framework of a lower portion of the car body 11, the battery unit 14 attached to the frame body 30, the undercover 20, etc. In FIG. 2, an arrow X indicates a longitudinal direction of the car body 11, and an arrow Y indicates a width direction of the car body 11. FIG. 3 shows a cross section of part of the vehicle 10 which is taken along the longitudinal direction.

The frame body 30 includes a pair of left and right side members 31 and 32 extending in the longitudinal direction of the car body 11, and cross members 33, 34, 35, 36 and 37 extending in the width direction of the car body 11. The cross members 33-37 are fixed to predetermined portions of the side members 31 and 32 by welding. The side members 31 and 32 and the cross members 33-37 are all formed of metal (e.g., steel), and also serve as electromagnetic shield members for shutting out an electromagnetic wave generated from a periphery of the battery unit 14.

The battery unit 14 includes a battery case 40, and a battery module 41 and an electronic circuit portion 42, which are provided in the battery case 40 (as shown by broken lines in FIG. 3). An example of the battery module 41 is a battery module in which a plurality of cells formed of lithium-ion batteries are connected in series to each other. The electronic circuit portion 42 includes a monitor which detects a state of the battery module 41 and an electronic component which exerts, e.g., control over the battery module 41; and it is electrically connected with the battery module 41.

The battery case 40 comprises a tray member 44 located on a lower side, and a cover member 45 stacked on an upper side of the tray member 44; and has a waterproof structure formed in the shape of a box. The tray member 44 and the cover member 45 are made as a single molded object formed of resin reinforced by, e.g., fiber. An insert member (not shown) is embedded in resin forming the tray member 44. The insert member is formed of metal, and can also function as an electromagnetic shield member.

As shown in FIG. 3, there is provided a floor panel 50 forming a floor portion of the car body 11. The floor panel 50 is formed of metal such as steel, which effects electromagnetic shielding. On a lower side surface of the floor panel 50, the battery unit 14 is provided. Thus, an upper side of the electronic circuit portion 42 of the battery unit 14 is shielded by the floor panel 50 against magnetism. The floor panel 50 also functions as a shield which prevents an electromagnetic wave generated from the battery unit 14 from propagating upwards.

As shown in FIGS. 2 and 3, a plurality of (e.g., four) beam members 51, 52, 53 and 54 are provided at a lower surface side of the battery case 40. The beam members 51, 52, 53 and 54 extend in the width direction of the car body 11. At a front end portion of the battery unit 14, a pair of front-side support members 55 are provided.

The beam members 51, 52, 53 and 54 have a strength sufficient to support a load of the battery unit 14, and are formed of metal material (e.g., steel plate) which effects electromagnetic shielding. The beam members 51, 52, 53 and 54 are fixed to the side members 31 and 32 of the car body 11 by bolts 57. The front-side support members 55 are fixed to the cross member 34 by bolts 57.

In such a manner, the battery unit 14 is supported by the frame body 30 from a lower side of the car body 11, with the beam members 51, 52, 53 and 54 and the front-side support members 55. The beam members 51, 52, 53 and 54 can also function as electromagnetic shield portions for a lower side of the battery unit 14, since they are located on a lower side of the battery case 40. The battery case 40 includes a front surface 40a, a rear surface 40b, both side surfaces 40c and 40d, and a bottom surface 40e, the front surface 40 and the rear surface 40b being located to face a front side and a rear side of the car body, respectively, with the battery case 40 fixed to the frame body 30.

The undercover 20 is provided under the car body 11, i.e., under the battery unit 14. In an example of the undercover 20, it is divided into an anterior half 20a and a posterior half 20b which are located on the front side and the rear side of the car body 11, respectively. The anterior half 20a and the posterior half 20b are connected with each other to form the undercover 20. The total length of the undercover 20 is greater than that of the battery unit 14. That is, the undercover 20 has a length sufficient to cover the battery case 40 from the front surface 40a to the rear surface 40b. Also, the undercover 20 has a width which is greater than that of the battery case 40.

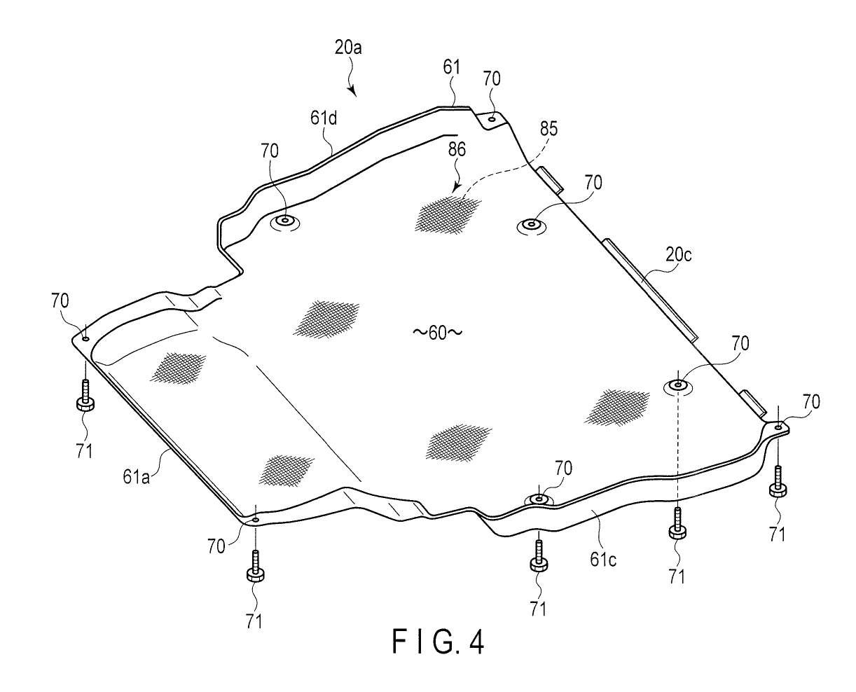

FIG. 4 shows an example of the anterior half 20a of the undercover 20. At a rear end of the anterior half 20a of the undercover 20, a connection portion 20c is provided for connection with the posterior half 20b. It should be noted that an undercover in which an anterior half 20a and a posterior half 20b are formed as a single body may be applied.

The undercover 20 includes a plate portion 60 which faces the bottom surface 40e of the battery case 40, and a convex edge 61 formed at a peripheral edge of the plate portion 60. The plate portion 60 and the convex edge 61 are formed of resin such as polypropylene (PP) and integral with each other. The undercover 20 may be formed of fiber reinforced resin (FRP). The plate portion 60 has an area sufficient to cover the bottom surface 40e of the battery case 40 as viewed from a lower side of the car body 11. An upper surface of the plate portion 60 faces lower surfaces of the beam members 51, 52, 53 and 54.

The convex edge 61 projects upwards at the peripheral edge of the plate portion 60. To be more specific, the convex edge 61 of the undercover 20 includes a front edge portion 61a, a rear edge portion 61b, and both side edge portions 61c and 61d. The front edge portion 61a is located closer to the front side of the car body 11 than the front surface 40a of the battery case 40. The rear edge portion 61b is located closer to the rear side of the car body 11 than the rear surface 40b of the battery case 40. The side edge portions 61c and 61d are located closer to outer sides of the car body 11 than the both side surfaces 40c and 40d of the battery case 40.

In the undercover 20, a plurality of bolt insertion holes (partially shown in FIG. 4) are formed. The bolt insertion holes 70 extend through the plate portion 60 in a thickness direction (vertical direction) thereof. When bolts 71 are respectively inserted through the bolt insertion holes 70, and then screwed into nut portions provided at the frame body 30, the undercover 20 is fixed to the car body 11 from the lower side of the car body 11.

As shown in FIG. 2, the undercover 20 is located over an area between the pair of left and right side members 31 and 32. A front end of the undercover 20 is fixed by bolts 71 to the cross member 33 which is the front one of the cross members. A center portion of the undercover 20 is fixed to the beam members 51, 52, 53 and 54. A rear end of the undercover 20 is fixed to the cross member 37 which is the rear one of the cross members (as shown in FIG. 2), with brackets interposed between the rear end and the cross member 37.

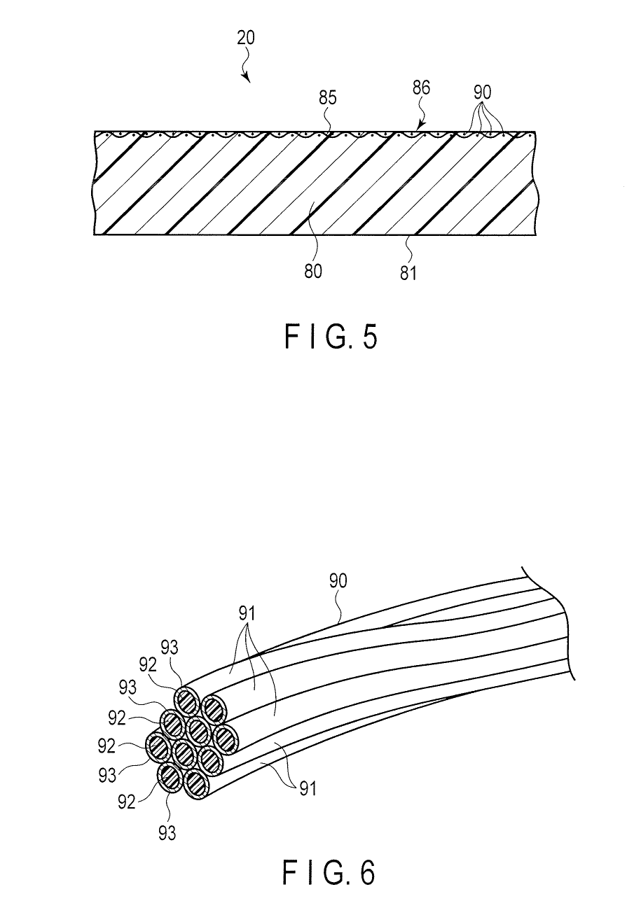

FIG. 5 is a cross-sectional view enlargedly and schematically showing part of the undercover 20. The undercover 20 comprises an undercover body 81 formed of resin and a cloth electromagnetic shield member 86. The undercover body 81 is made by molding resin 80 such as polypropylene in a predetermined shape. A conductive fabric 85 is provided on, e.g., an upper side of the undercover body 81. FIG. 4 shows part of the cloth electromagnetic shield member 86, which is formed of the conductive fabric 85. The undercover body 81 is located opposite to the bottom surface 40e of the battery unit 14. The conductive fabric 85 is stacked on the undercover body 81.

The cloth electromagnetic shield member 86 prevents an electromagnetic wave generated from, e.g., the electric motor 12, from propagating from the lower side of the car body 11 to the electronic circuit portion 42 (shown in FIG. 3) in the battery case 40. That is, the undercover 20 provided with the cloth electromagnetic shield member 86 functions as a lower-side electromagnetic shield portion for preventing an electromagnetic wave from propagating from the lower side of the battery unit 14.

FIG. 6 shows part of a conductive thread 90 which forms the conductive fabric 85. The conductive thread 90 is made of a plurality of conductive fibers 91. The conductive fabric 85 comprises conductive fibers 91 woven thereinto. The conductive fibers 91 are bicomponent fibers which are made of fiber bases 92 and conductive layers 93 covering the fiber bases 92. The fiber bases 92 are formed of, e.g., polyethylene terephthalate (PET). The conductive layers 93 are formed of metal such as copper. The conductive layers 93 are provided on outer peripheral surfaces of the fiber bases 92 by coating means such as electroless plating. In such a manner, the cloth electromagnetic shield member 86 in the embodiment is formed of the conductive fabric 85 into which the conducive fibers 91 are woven. Furthermore, in the embodiment, as a rustproofing measure for the conductive fibers 91, protection layers are provided on outer portions of the conductive layers 93. The protection layers are formed of rustproof metal such as nickel.

Fineness of the conductive fibers 91 is not limited to a specific one. It is preferable that the conductive fibers 91 be sufficiently flexible such that they can follow an inner surface of a die when the undercover 20 is molded by the die. Thus, conductive fibers 91 having fineness of, e.g., 200 denier (approximately 22 tex) or less are adopted. In general, it is appropriate that the conductive fibers 91 have a volume resistivity of 10⁷ Ω·cm or less, and it is preferable that they have a volume resistivity of 10² Ω·cm or less.

The undercover 20 is formed by a molding method using a die, such as hot pressing or a stamping molding. The conductive fabric 85 has flexibility and is soft. Thus, the conductive fabric 85 can be stuck along an inner surface of the die by vacuum suction means for generating a negative pressure. That is, the conductive fabric 85 is provided on the plate portion 60 of the undercover body 81, and preferably also on the convex edge 61, which is located in a periphery of the plate portion 60. That is, edge portions of the conductive fabric 85 are provided at the front edge portion 61a, rear edge portion 61b and both side edge portions 61c and 61d of the plate portion 60. In such a manner, the conductive fabric 85 may be provided over an area surrounded by the convex edge 61.

The conductive fabric 85 in the embodiment is provided over the convex edge 61 and the plate portion 60 of the undercover body 81. Thus, in the embodiment, the undercover 20 including the conductive fabric 85 has a higher electromagnetic shield effect in the longitudinal direction and transverse direction of the battery unit 14, compared with a conventional undercover in which no electromagnetic shield member is provided for a convex edge 61.

Between the resin 80 and the conductive fabric 85 of the undercover body 81, a boundary surface is present where the conductive fabric 85 and the resin 80 contact each other. At the boundary surface, when the resin 80 is melted at the time of molding the undercover 20, the resin 80 and the conductive fabric 85 are fixed to each other due to an adhesive property of the melted resin 80. Furthermore, the resin 80 enters the conductive thread 90 of the conductive fabric 85, and cures, thereby obtaining an anchor effect. This anchor effect can enhance a strength of fixing of the conductive fabric 85 to the undercover 81.

In such a manner, by the conductive fabric 85 in which the resin 80 of the undercover body 81 is melted, the resin 80 of the undercover body 81 is strengthened like fiber reinforced resin (FRP). It is therefore possible to prevent amplification of damage of the undercover 20 such as a fracture which would be caused when the vehicle hits on an obstruction or a stone leaping for driving. Thus, the strength of the undercover 20 is enhanced.

The undercover 20 according to the embodiment is fixed to the metallic frame body 30 by bolts 71. These bolts 71 penetrate the undercover body 81 and the conductive fabric 85 in a thickness direction (vertical direction). That is, the undercover 20 is fixed to the frame body 30 of the car body 11 by bolts 71 inserted from the lower side of the car body 11. To be more specific, in this case, a metallic bolt or bolts 71 inserted into the bolt insertion holes 70 of the undercover 20 penetrate the conductive fabric 85. As a result, the bolts 71 are fixed to the frame body 30, while at least one of the bolts 71 is in contact with the conductive fabric 85.

That is, while at least one bolt 71 is in contact with the conductive fabric 85, the bolts 71 fix the undercover 20 to metallic frame members (such as the side members 31 and 32, the cross members, etc.). Thus, the cloth electromagnetic shield member 86 formed of the conductive fabric 85 is grounded through the car body 11, which is metallic. Therefore, the electromagnetic shield effect by the conductive fabric 85 can be improved.

The undercover 20 also has a function of smoothening an airflow which is generated on a lower-surface side of the car body 11 during driving, and can thus reduce an air resistance during driving. The undercover 20 also functions as a lower-side electromagnetic shield portion for shutting out an electromagnetic wave from the lower side of the battery unit 14. In addition, under the battery unit 14, the metallic beam members 51, 52, 53 and 54 are arranged which function as lower-side shield portions. Since the undercover 20 comprises the beam members 51, 52, 53 and 54 and the cloth electromagnetic shield member 86, it can obtain a greater electromagnetic shield effect.

In a given vehicle, an electronic component which generates an electromagnetic wave is provided between the floor panel 50 and the undercover 20. In this case, an electromagnetic wave generated by the electronic component can be prevented from affecting electronic devices located above the floor panel 50, such as a radio, an electronic clock and a navigation system. To be more specific, an electromagnetic wave generated by the electronic component can be shut out by the floor panel 50 and the cloth electromagnetic shield member 86 provided at the undercover 20.

It should be noted that the cloth electromagnetic shield member 86 of the undercover 20 may be provided only at part of the undercover 20 in accordance with an intensity of an electromagnetic wave which propagates from the lower side of the car body 11 to reach the battery unit 14, and the range of propagation of the electromagnetic wave.

With electromagnetic shield means including the undercover 20 as explained above, it is possible to prevent an electromagnetic wave generated from an area located outside the battery case 40 from affecting the electronic circuit portion 42 in the battery case 40. It is also possible to prevent an electromagnetic wave generated in the battery case 40 from propagating to the outside of the undercover 20 therethrough. Thus, it is not necessary to provide an electromagnetic shield member such as a wire net, for the battery case 40, which would cause electrical shortings. Thus, it is safe.

As explained above, according to the embodiment, in the entire undercover 20, the area of which is greater than that of the battery unit 14, an electromagnetic shield member is provided which is formed of a conductive fabric. Thus, even if the shape and location of the battery unit 14 are changed, the undercover 20 to be used can be unchanged. Also, even an electronic component provided outside the battery unit 14 can be shielded by the undercover 20 from an electromagnetic wave.

In such a manner, in the undercover 20, the undercover body 81 and the conductive fabric 85 are united with each other. Such an undercover 20 is provided under the car body 11. By virtue of this structure, the conductive fabric 85 united with the resin 80 can restrict to some extent, shaking and vibration of the undercover 20 which are caused by wind blowing during driving. The conductive fabric 85 can also restrict cracking of the undercover 20 to some extent.

It should be noted that a wire net could be considered to be provided on an undercover as an electromagnetic shield member; however, it causes an inner surface of a die to be damaged at the time of molding the undercover. Furthermore, it was impossible to mold the undercover body and resin into a single body due to stiffness of a wire net and instability of the shape of the wire net which would be caused by springback. In addition, if a wire net is provided on the undercover, clips and screw members need to be provided to fix the wire net. Thus, holes for insertion of the clips need to be formed in part of the wire net, and there is a possibility that an electromagnetic shield effect cannot be obtained at the locations of the formed holes.

Therefore, in the embodiment, as described above, the conductive fabric 85 and the resin 80 are molded into a single body at the time of molding the undercover 20 with a die due to heat. Thus, after molding, it is not necessary to carry out a step of fixing the conductive fabric 85 to the undercover body 81 with clips and screw members. In addition, the undercover 20 molded such that the resin 80 and the conductive fabric 85 are molded into the single body needs no holes for insertion of clips for fixing the electromagnetic shield member. It is therefore possible to reduce the number of portions having no electromagnetic shield effect to a minimum.

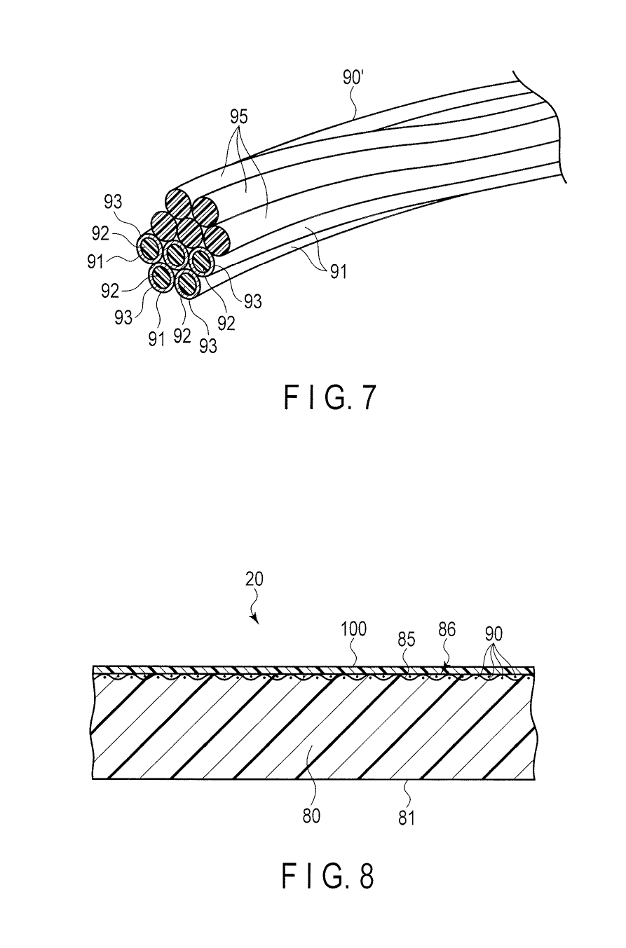

FIG. 7 shows a conductive thread 90′ forming a conductive fabric in an undercover according to a second embodiment. The undercover according to the second embodiment is the same as the undercover 20 according to the first embodiment, except for the structure of the conductive thread 90′. The conductive thread 90′ is formed of conductive fibers 91 and nonconductive fibers 95. The conductive fibers 91, as well as those of the first embodiment, include fiber bases 92 and conductive layers 93 covering the fiber bases 92. The fiber bases 92 are formed of resin such as PET. The conductive layers 93 are formed of metal or the like.

The nonconductive fibers 95 are formed of resin only, such as PET, and do not have conductivity. However, the nonconductive fibers 95 have compatibility with the resin 80 of the undercover body 81. The compatibility is a property in which two or more different kinds of materials have an affinity for each other, and can be mixed into a single body, while being stacked and melted together, as for example, polyethylene terephthalate (PET) and polypropylene (PP). The conductive fibers 91 have a volume resistivity of, e.g., 10⁷ Ω·cm or less. The nonconductive fibers 95 have a volume resistivity of, e.g., 10¹⁴ to 10¹⁶ Ω·cm.

In the second embodiment, the nonconductive fibers 95 and resin 80 of the undercover body 81 are formed of respective resin having compatibility with each other. Thus, a conductive fabric 85 into which the conductive fibers 91 and the nonconductive fibers 95 are woven can be further strongly fixed to the undercover body 81 due to the compatibility between the nonconductive fibers 95 and the resin 80 of the undercover body 81.

It should be noted that as another example of the conductive fabric 85 forming a cloth electromagnetic shield member 86, a fabric or a nonwoven fabric may be applied which is formed of a complex material which is a combination of metal fibers and fibers obtained by subjecting fibers, copper, nickel, etc. to electroless plating. That is, any cloth may be applied as long as it has conductivity and is flexible such that it can follow an inner surface of a die. Such a conductive fabric is pressurized along with the resin 80 of the undercover body 81 in a thickness direction by a stamping molding or hot pressing using a die, while they are being heated. Thereby, an undercover 20 can be obtained in which the resin 80 and the conductive fabric 85 are molded into a single body.

FIG. 8 shows part of an undercover 20 according to a third embodiment. In a conductive fabric 85 forming the undercover 20, a surface located opposite to an undercover body 81 (i.e., an upper surface of the conductive fabric 85) is covered by a laminate resin layer 100. The laminate resin layer 100 and resin 80 of the undercover body 81 are formed of respective resin having compatibility for each other. At the time of performing heat molding using a die, the resin 80 of the undercover body 81 seeps from the conductive fabric 85 to the laminate resin layer 100 to unite with the laminate resin layer 100. As a result, the undercover body 81 and the conductive fabric 85 are further strongly fixed to each other. Furthermore, an upper surface (outer surface side) of the conductive fabric 85 is covered by the laminate resin layer 100. In this case, the undercover body 81 is made waterproof. Thus, even if conductive layers 93 of conductive fibers 91 forming the conductive fabric 85 are formed of copper only, and are not covered by anticorrosive metal, the conductive fibers 91 can be prevented from rusting.

In the above explanations of the above embodiments, although a vehicle (electric car) to be driven by an electric motor only is referred to, the present invention can also be applied to a hybrid vehicle provided with an electric motor and an engine (internal combustion engine). Furthermore, needless to say, when the present invention is put to practical use, the structures and locations of structural elements of the invention, as well as the concrete shapes of the car body and the battery unit, and the shapes and locations of the undercover and the conductive fabric, can be modified as appropriate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims.

What is claimed is:

1. An undercover provided under a battery unit mounted on a lower portion of a vehicle comprising:
an undercover body formed of resin and located opposite to a bottom surface of the battery unit; and
a conductive fabric stacked on the undercover body, the conductive fabric comprising conductive fibers woven thereinto;
wherein the undercover body is melted and stuck to the conductive fabric.

2. The undercover of claim 1, wherein a convex edge is provided at a peripheral edge of the undercover body to project upwards, and the conductive fabric is provided over an area surrounded by the convex edge.

3. The undercover of claim 1, wherein a metallic bolt is provided to penetrate the undercover body and the conductive fabric in a thickness direction, and the bolt fixes the undercover to a metallic frame member of a car body, while being in contact with the conductive fabric.

4. The undercover of claim 2, wherein a metallic bolt is provided to penetrate the undercover body and the conductive fabric in a thickness direction, and the bolt fixes the undercover to a metallic frame member of a car body, while being in contact with the conductive fabric.

5. The undercover of claim 1, wherein a laminate resin layer is stacked on an upper surface of the conductive fabric.

6. The undercover of claim 2, wherein a laminate resin layer is stacked on an upper surface of the conductive fabric.

7. The undercover of claim 3, wherein a laminate resin layer is stacked on an upper surface of the conductive fabric.

8. The undercover of claim 4, wherein a laminate resin layer is stacked on an upper surface of the conductive fabric.
